(19) United States
(12) Patent Application Publication
(10) Pub. No.: US 2007/0271003 A1
(43) Pub. Date: Nov. 22, 2007

(54) Robot using absolute azimuth and mapping method thereof

(75) Inventors: Seok-won Bang, Seoul (KR); Su-jinn Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/594,163

(22) Filed: Nov. 8, 2006

(30) Foreign Application Priority Data
May 16, 2006 (KR) 10-2006-0043988

(51) Int. Cl. G06F 19/00

(52) U.S. Cl. 700/245; 701/23

(57) ABSTRACT

A robot using an absolute azimuth to navigate and a mapping method thereof. The robot includes a control unit controlling a traveling direction of a body of the robot by using the absolute azimuth, which indicates an orientation of the body with respect to a specified reference axis, and a drive unit moving the body under the control of the control unit.

### CROSS-REFERENCE TO RELATED APPLICATION

This application is based on and claims priority from Korean Patent Application No. 10-2006-0043988, filed on May 16, 2006 in the Korean Intellectual Property Office, the disclosure of which is incorporated herein by reference.

### BACKGROUND OF THE INVENTION

1. Field of the Invention

The present invention relates to a robot using an absolute azimuth and a mapping method thereof and, more particularly, to a robot using an absolute azimuth to navigate and a mapping method thereof, in which the traveling path of a robot body can be controlled using the absolute azimuth and the mapping of a specified area can be promptly performed.

2. Description of Related Art

Recently, with the development of robotics and related technologies, diverse types of robots have appeared. In particular, self-driving robots have been developed to perform domestic tasks for humans.

Generally, a robot includes a drive part (e.g., wheels) equipped with an encoder (also referred to as “odometry”) to estimate the position of the robot, and/or a gyroscope (hereinafter referred to as “gyro” or “gyro sensor”) to precisely measure the rotation angle of the robot.

When mapping an area experienced by the robot for the first time, the robot moves along a wall (i.e., wall following), and estimates the position using the gyro and the encoder. Here, the robot draws a map while being in a predetermined distance from the wall. Specifically, a traveling trace of the robot in a given area forms the map, and successive operations are performed to accurately control the motion of the robot and accurately estimate the position of the robot. When the robot performs the successive operations using the gyro and the encoder, an azimuth error is accumulated as time elapses. Therefore, the robot may produce an inaccurate map. For example, when the position of the robot is estimated, an error occurs due to the slippage or mechanical drift of wheels. Although such an error is insignificant, the accumulated error may cause a serious problem.

U.S. Pat. No. 4,821,192 entitled “Node Map System and Method for Vehicle”, discusses a mapping system for a vehicle requires a beacon, and a map is generated by interconnecting nodes. However, a direction of a path from a node to a next node may be a certain angle. Also, the moving object mapping system does not configure 2-dimensional arrangements of actual walls as a map, but configures the map using nodes, paths, and directions. The direction is measured not by using an absolute azimuth of compass (hereinafter referred to as “compass sensor”), but by using the azimuth relative to the beacon.

Also, the self-driving robot calculates its relative position at an initial position after the robot initially calculates its absolute position from a reference point, and then converts it into absolute coordinates. However, this method has a problem that the relative distance and angle are detected from the initial absolute position, and this causes errors to be accumulated.

Consequently, there is a need for a robot that accurately draws the map in a short time, and which avoids error accumulation.

### BRIEF SUMMARY

Accordingly, an aspect of the present invention provides a robot using an absolute azimuth and a mapping method thereof.

According to the present invention, there is provided a robot using an absolute azimuth to navigate which includes a control unit controlling a traveling direction of a body of the robot by using the absolute azimuth, which indicates an orientation of the body with respect to a specified reference axis, and a drive unit moving the body under the control of the control unit.

According to another aspect of the present invention, there is provided a mapping method of a robot using an absolute azimuth for navigation, including: controlling a traveling direction of a body of the robot using the absolute azimuth, which indicates an orientation of the body with respect to a specified reference axis; and moving the body under control of a control unit.

According to another aspect of the present invention, a robot, including: a drive unit advancing the robot along a traveling path in a specified area; a compass unit outputting information about an absolute azimuth indicating an orientation of the robot; a sensor unit sensing a distance between the robot and an obstacle; a control unit determining, using the sensed distance, an absolute azimuth of the obstacle based on the measured distance, when the obstacle is on the side of the robot, based on an average value of the absolute azimuth measured for a specified time, turning the robot in accordance with the measured absolute azimuth of the obstacle so that the absolute azimuth of the robot is parallel to the absolute azimuth of the obstacle, then moving the robot forward by turning the robot according to the measured absolute azimuth of the obstacle so that the absolute azimuth of the robot is parallel to the absolute azimuth of the obstacle; and a drawing unit mapping the specified area based on the traveling path of the robot and, when the traveling path is a closed loop, smoothing a generated map.

According to another aspect of the present invention, a method of improving an accuracy of mapping of a specified area, including: advancing a robot along traveling path; outputting information indicating an orientation of the robot; sensing a distance between the robot and an obstacle; determining, using the sensed distance, an absolute azimuth of the obstacle based on an average value of the absolute azimuth indicating an orientation of the body measured for a specified time; mapping the specified area based on the traveling path; and determining whether the traveling path of the body forms a closed loop and smoothing the map when the traveling path of the body forms a closed loop.

According to another aspect of the present invention, a robot, including: a control unit controlling movement of the robot in a specified area using an absolute azimuth of the robot so that the robot maintains a predetermined distance range from an obstacle positioned on a side of the robot, by moving the robot forward and/or toward in a specified direction at a right angle, on the basis of a center azimuth of an interior of the specified area; and a drawing unit mapping the specified area using information from the control unit based on a traveling path of the robot. The absolute azimuth is an angle inclined with respect to a reference axis and indicating an orientation of the robot with respect to the reference axis. The reference axis is a center azimuth of an interior of the specified area.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIGS. 1A and 1B are views illustrating a configuration of a robot using an absolute azimuth according to an embodiment of the present invention;

FIG. 2 is a flowchart illustrating a mapping method of a robot using an absolute azimuth according to an embodiment of the present invention;

FIG. 3 is a detailed flowchart illustrating a mapping process S251 of a robot using an absolute azimuth according to an embodiment of the present invention;

FIGS. 4A and 4B are views explaining the process of measuring an absolute azimuth of an obstacle initially positioned on a side of a body according to an embodiment of the present invention;

FIGS. 5A and 5B are views illustrating a traveling route of a robot using an absolute azimuth and an example of performing mapping of the robot based on the traveling route, according to an embodiment of the present invention;

FIGS. 6A and 6B are views displaying the results of a simulation on a traveling path of a robot using an absolute azimuth according to an embodiment of the present invention; and

FIGS. 7A and 7B are views illustrating examples of a map smoothing technique.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

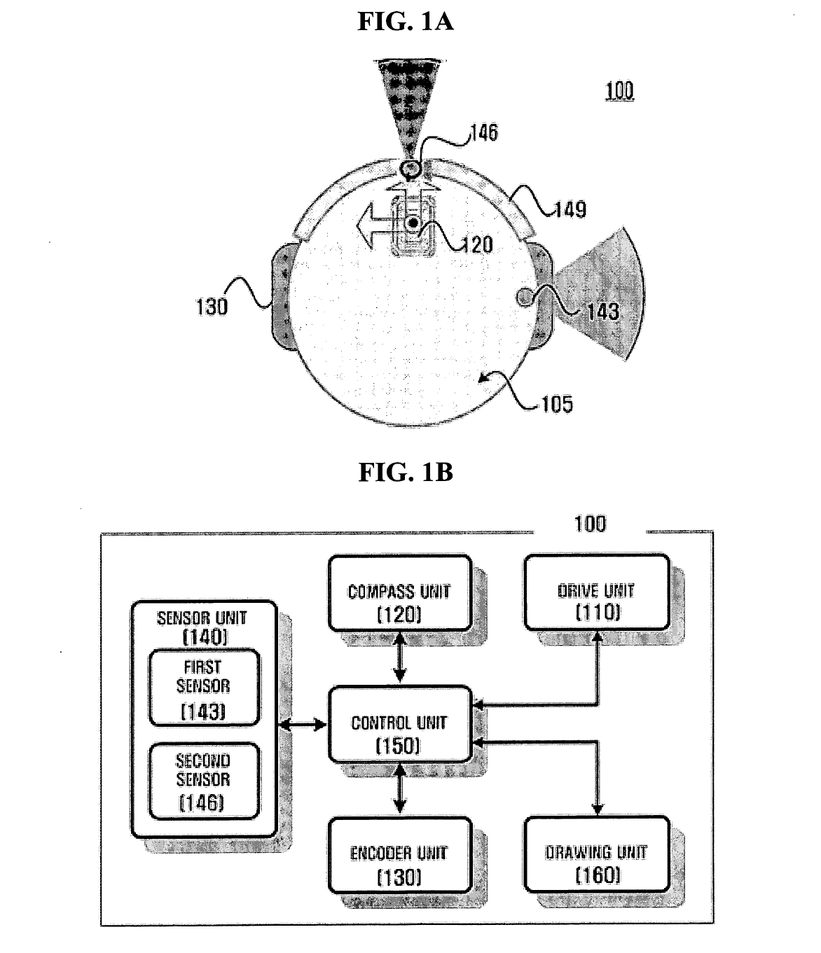

FIGS. 1A and 1B are views illustrating a configuration of a robot 100 using an absolute azimuth, according to an embodiment of the present invention.

FIG. 1A is a plan view illustrating an example of a configuration of the robot 100. FIG. 1B is a block diagram illustrating components of the robot 100.

Referring to FIGS. 1A and 1B, the robot 100 according to the present embodiment includes a drive unit 110 driving a body 105, a compass unit 120, an encoder unit 130, a sensor unit 140, a control unit 150, and a drawing unit 160.

The drive unit 110 moves the body 105 under the control of the control unit 150, which will be described hereinafter. The drive unit 110 may include, as a non-limiting example, wheels as a driving means. The driving unit 110 moves the body 105 back and forth and turns the body 105.

The compass unit 120 outputs information on the absolute azimuth indicating an orientation of the body 105 with respect to a specified reference axis. The absolute azimuth is an angle inclined with respect to a reference line (axis) defined in an absolute coordinate system. The absolute coordinate system is also referred to as a stationary coordinate system, and is a coordinate system that exists on the same position regardless of the movement of an object. An angle inclined with respect to a true north may be absolute azimuth in the absolute coordinate system in which the true north of earth (reference line) seems to be one of axes. If a direction toward a veranda is defined as an x-axis of the absolute coordinate system and a direction perpendicular to the veranda is defined as a y-axis, an angle inclined with respect to the direction toward the veranda may be the absolute azimuth. That is, the coordinate system fixed regardless to the movement of the body 105 may be the absolute coordinate system, and the angle inclined with respect to the absolute coordinate system may be the absolute azimuth. Thus, the compass unit 120 enables prompt, accurate mapping by using the absolute azimuth, without accumulating errors of azimuth.

The encoder unit 130 detects the motion of the drive unit 110 to output at least one of traveling distance, traveling speed, and turning angle of the body 105.

The sensor unit 140 senses and outputs a distance between the body 105 and an obstacle. The sensor unit 140 includes a first sensor 143 outputting information on a distance between the body 105 and an obstacle positioned on the side of the body on the basis of the traveling direction of the body 105, and a second sensor 146 outputting information on a distance between the body 105 and an obstacle positioned in the center of (i.e., in front of) the body on the basis of the traveling direction of the body 105. Each of first and second sensors 143 and 146 may include, by way of non-limiting examples, an ultrasonic sensor, an infrared sensor, or a laser sensor. For example, the sensor unit 140 can measure the distance between the body 105 and the obstacle through a time difference between a time when supersonic waves are emitted toward the obstacle and a time when the waves are reflected and returned.

Also, the sensor unit 140 includes a contact detecting sensor mounted on the body 105 to detect whether the body 105 comes in contact with the obstacle. If it is detected the body 105 contacts the obstacle, the sensor unit 140 outputs this information to the control unit 150, so that the body 105 may maintain a specified distance from the obstacle. For example, a bumper 149 is mounted on the sensor unit 140 as the contact detecting sensor, so as to detect whether the body 105 comes in contact with the obstacle.

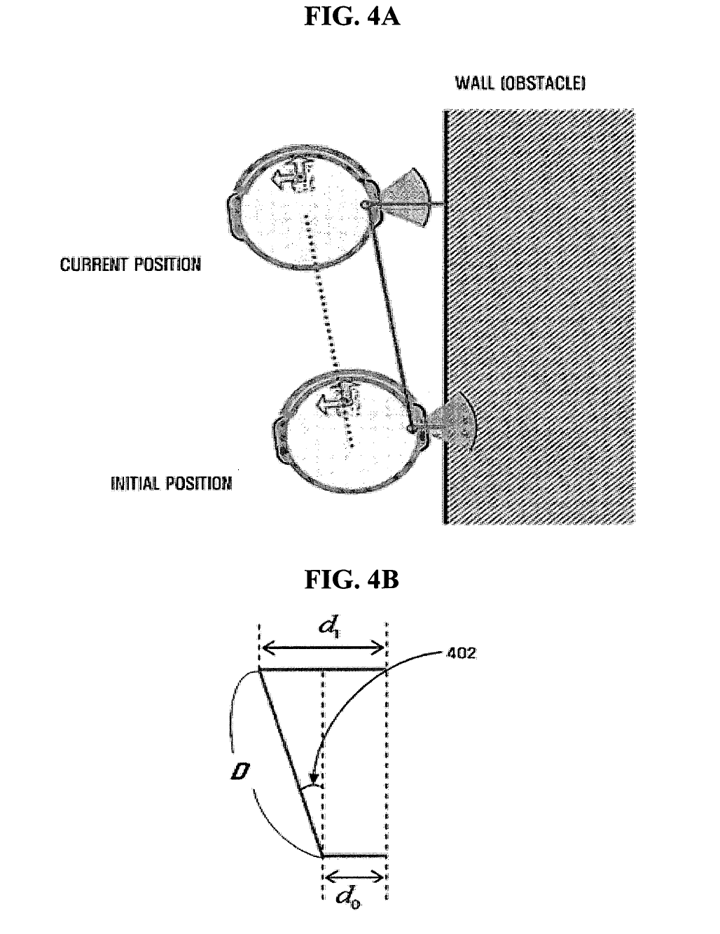

The control unit 150 controls the traveling direction of the body 105 using the absolute azimuth indicating the orientation of the body 105 with respect to a specified reference axis. The control unit 150 turns the body 105 in accordance with the absolute azimuth of the obstacle positioned on the side of the body 105 by use of at least one of information provided from the compass unit 120, the encoder unit 130, and the sensor unit 140, so that the body 105 is positioned in a predetermined distance from the absolute azimuth of the obstacle positioned on the side of the body 105. The center azimuth of the interior of the specified area means a reference line of the interior of the specified area. That is, the absolute azimuth of the obstacle positioned on the side of the body is measured when the center azimuth of the interior of the specified area is initially set. In the subsequent control, it may not be advantageous to measure the absolute azimuth of the obstacle positioned on the side of the robot. If the center azimuth of the interior of the specified area which is a reference line is initially set, the center azimuth of the interior of the specified area initially set is used as the reference value to be used in the subsequent control. The absolute azimuth of the obstacle positioned on the side of the body 105 is measured by subtracting an angle formed by the body 105 and the obstacle positioned on the side of the body 105 from the absolute azimuth indicating the orientation of the body 105 measured during a specified time, which will be described in detail hereinafter with reference to FIGS. 4A and 4B.

When a conventional robot maps a specified area, the robot is continuously controlled by use of an algorithm so that the robot travels in parallel with an obstacle positioned on the side of the robot according to a wall-following method. In the present embodiment, however, the control unit 150 performs the simple operation by moving the body 105 forward and turning the body 105 toward a specified direction at a right angle so as to maintain the distance between the body 105 and the obstacle positioned on the side or front of the body 105 at a specified range. Therefore, the robot can perform mapping of the traveling path of the body 105 promptly. That is, when the body 105 moves forward, the control unit 150 turns the body 105 toward a specified direction at a right angle so that the distance between the body 105 and the obstacle positioned on the side of the body 105 is within a desired range on the basis of the center azimuth of the specified area (referred to as “center azimuth”), when the distance between the body 105 and the obstacle positioned on the front of the body is shorter than a specified distance or the body 105 collides against the obstacle positioned on the front of the body 105.

Also, when the distance between the body 105 and the wall positioned on the side of the body 105 is longer than a specified distance, the control unit 150 turns the body 105 toward a specified direction at a right angle so that the distance between the body 105 and the obstacle positioned on the side of the body 105 is within a desired range.

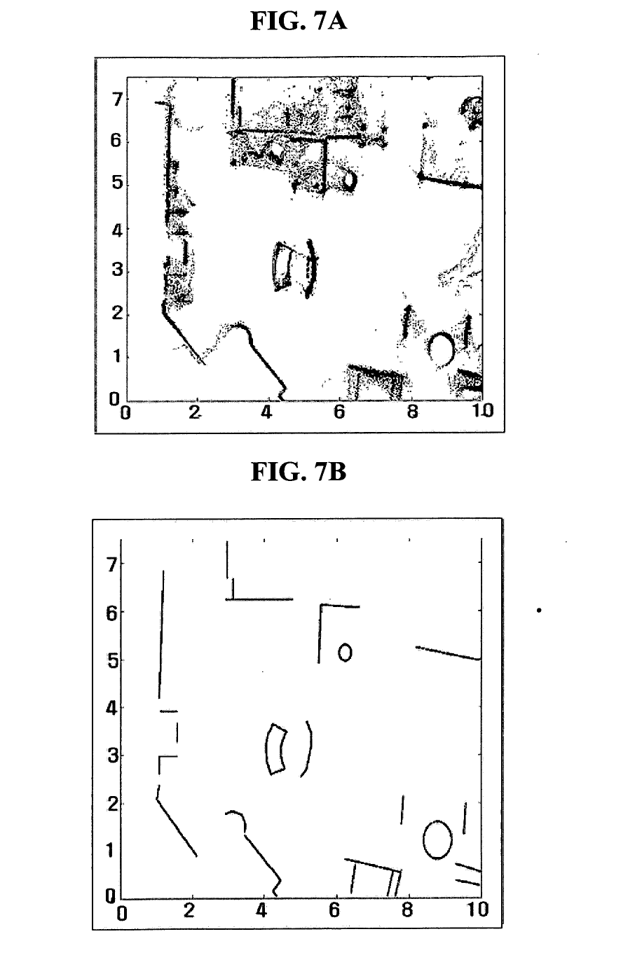

The drawing unit 160 performs the mapping using information from the control unit 150, which may include information output from the first side sensor 143, based on the traveling path of the body 105. In this instance, the produced map may be a grid map, or a geometric map in which a grid map produced by the drawing unit 160 is subjected to a smoothing process, which is described in detail with reference to FIGS. 7A and 7B.

In the present embodiment, the respective components as illustrated in FIGS. 1A and 1B may be constructed as modules. Here, the term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

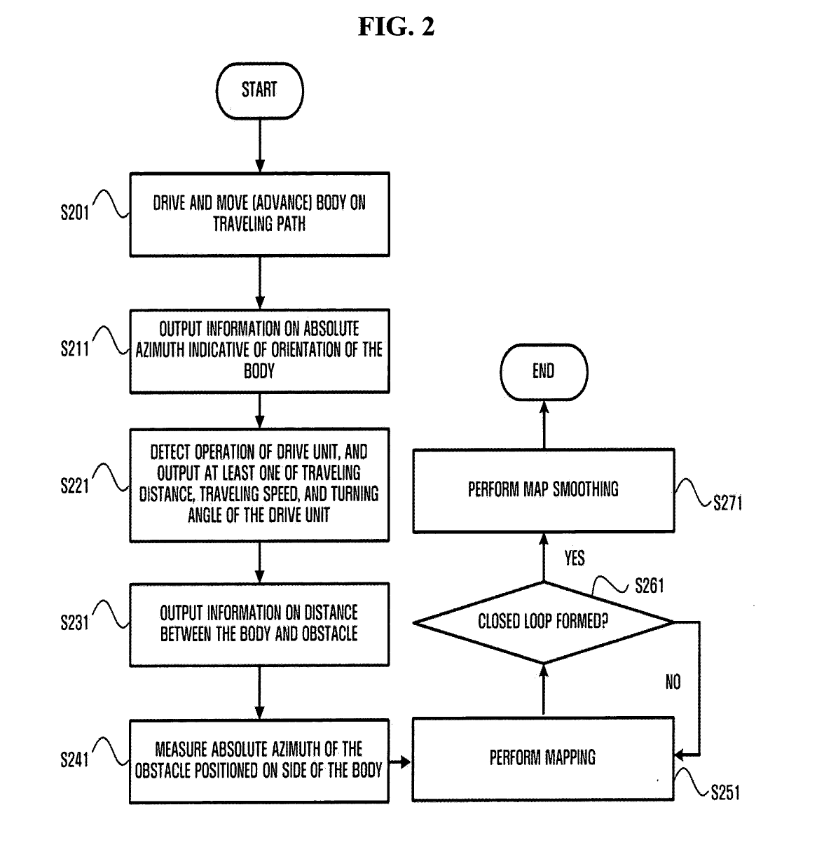

FIG. 2 is a flowchart illustrating a mapping method according to an embodiment of the present invention. The method is described hereinafter with concurrent reference to the robot 100 of FIGS. 1A and 1B, for ease of explanation only. It is to be understood that this method is not limited to the robot of FIGS. 1A and 1B.

Since the structures have a vertical relation in the house, a center azimuth in the house is determined, and the mapping of a specified area may be easily performed by using an algorithm moving the robot 100 in a direction perpendicular to the direction of the center azimuth. In the description of FIG. 2 that follows, descriptions duplicative of those of FIGS. 1A and 1B have been omitted.

Referring to FIGS. 1A, 1B, and 2, the drive unit 110 drives the body 105, and moves the body forward on the traveling path (S201). The drive unit 110 may be, by way of a non-limiting example, a wheel-type drive means such as a wheel.

At that time, the compass unit 120 outputs the information on the absolute azimuth indicating the orientation of the body 105 (S211). The compass unit 120 may be, by way of a non-limiting example, a compass sensor.

Also, the encoder unit 130 detects the operation of the drive unit 110 to output at least one of a traveling distance, a traveling speed, and a turning angle of the body 105 (S221). More specifically, the encoder unit 130 detects motion of the wheel to output information on the traveling distance, traveling speed, and turning angle of the body 105. The encoder unit 130 may be, by way of a non-limiting example, an encoder sensor.

Also, the sensor unit 140 senses and outputs the distance between the body 105 and the obstacle (S231). The sensor unit 140 includes the first sensor 143 outputting the information on the distance between the body 105 and the obstacle positioned on the side of the body 105 on the basis of the traveling direction of the body 105, and the second sensor 146 outputting information on the distance between the body 105 and the obstacle positioned on the center of (i.e., in front of) the body on the basis of the traveling direction of the body 105. Each of the first and second sensors 143 and 146 may include an ultrasonic sensor, an infrared sensor, or a laser sensor.

The bumper 149 is mounted on the body 105 to detect whether the body 105 comes into contact with the obstacle. For example, the bumper can be configured so as to generate a signal when the bumper 149 contacts the obstacle, such as by the pressing of a switch.

The aforementioned operations S211 through S231 may be executed in orders that differ from that illustrated in FIG. 2, such as, for example, in reverse or simultaneously.

Next, the control unit 150 determines, using the information of the distance between the body and the obstacle, the absolute azimuth of the obstacle positioned on the side of the body 105 based on an average value of the absolute azimuth indicating the orientation of the body 105 measured for a desired time S241. The control unit 150 turns the body 105 in accordance with the absolute azimuth of the obstacle positioned on the side of the body 105 so that the absolute azimuth of the body 105 is in parallel with the absolute azimuth of the obstacle. Then, the control unit 150 moves the body 105 forward. To this end, the control unit 150 turns the body 105 according to the absolute azimuth of the obstacle positioned on the side of the body 105 by use of at least one of the information outputted from the compass unit 120, the encoder unit 130, and the sensor unit 140, so that the absolute azimuth of the body 105 is in parallel with the absolute azimuth of the obstacle.

Then, the drawing unit 160 performs the mapping based on the traveling path of the body 105 S251. The produced map may be, by way of a non-limiting example, a grid type map.

After operation S251, it is determined whether the traveling path of the body forms a closed loop. If the traveling path of the body 105 forms a closed loop, the drawing unit 160 again produces the geometric map in which the produced grid type map has been subjected to the smoothing process (operation S271). At that time, the drawing unit 160 may update the grid map and process the smoothing in real time to produce the geometric map. If the traveling path of the body 105 does not form a closed loop, operation S251 is repeated.

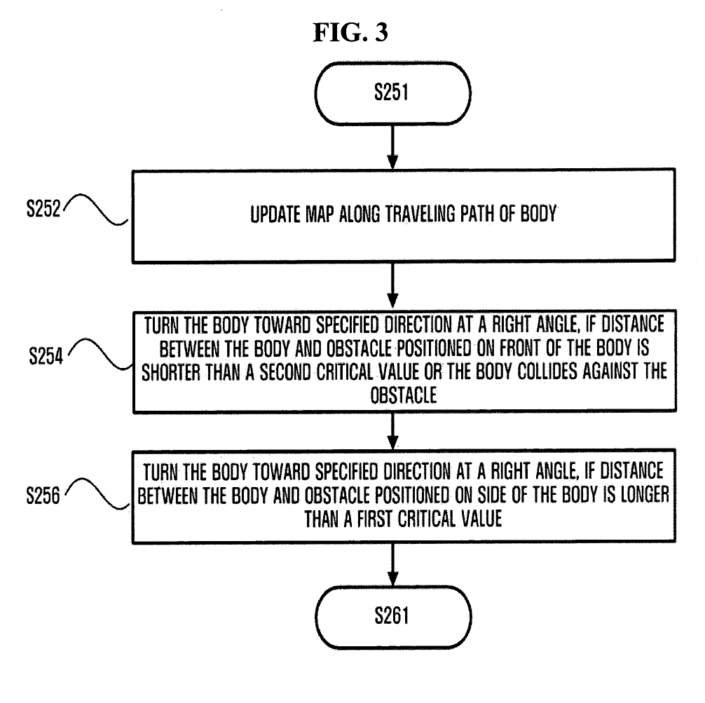

FIG. 3 is a detailed flowchart illustrating the mapping process of operation S251.

Before the drawing unit performs the mapping, the control unit 150 turns the body 105 according to the absolute azimuth of the obstacle positioned on the side of the body 105, so that the absolute azimuth of the body 105 is in parallel with the absolute azimuth of the obstacle.

When the body 105 moves forward, the drawing unit 160 performs the mapping by updating the map according to the traveling path of the body 105 S252. When the body 105 moves forward, the control unit 150 performs the control operation by turning the body 105 toward a specified direction at a right angle so as to maintain the distance between the body 105 and the obstacle positioned on the side or front of the body 105 at a specified range. Therefore, the robot can perform the mapping for the traveling path of the body 105 promptly. That is, when the body 105 moves forward, the control unit 150 controls the body 105 to maintain the distance between the body 105 and the obstacle positioned on the side of the body 105 at a specified range, when the obstacle is positioned on the front of the body 105 or the distance between the body 105 and the obstacle is longer than the specified distance.

For example, when the body 105 moves forward, the body 105 is controlled to move away from the wall to maintain the distance between the body 105 and the wall at a specified range, when the body 105 contacts the wall, since the wall positioned on the right side of the body 105 is convex and thus the distance between the body 105 and the wall is shorter than the specified distance. Also, when the body 105 moves forward, the body 105 is controlled to be close to the wall to maintain the distance between the body 105 and the wall at a specified range, when the wall positioned on the right side of the body 105 is concave or is bent outwardly and thus the distance between the body 105 and the wall is longer than the specified distance. When the body 105 is controlled to go away from the front/side wall (i.e., the obstacle) or to be close to the obstacle, the control unit 150 performs the operation of turning the body 105 perpendicularly (i.e., a right angle).

In operations S254 and S256, the control unit 150 controls the body 105 according to the distance between the body 105 and the obstacle positioned in front of or on the side of the body 105 or contact therewith, based on the above principle, while the body 105 moves forward, in performing the mapping through the drawing unit 160. The processes S254 and S256 may be executed in reverse.

In operation S254, when the body 105 moves forward, the control unit 150 turns the body 105 toward a specified direction at a right angle on the basis of the center azimuth of the interior of the specified area (i.e., the house), when the distance between the body 105 and the obstacle positioned on the front of the body 105 is shorter than a second critical value or the body 105 contacts the obstacle positioned in front of the body. For example, the control unit 150 turns the body 105 toward a left direction at a right angle on the basis of the center azimuth, when the body 105 moves, while the wall is positioned on the right side of the body 105, when the distance between the body 105 and the wall positioned on the front of the body 105 is shorter than the second critical value, or when the body 105 contacts the wall positioned on the front.

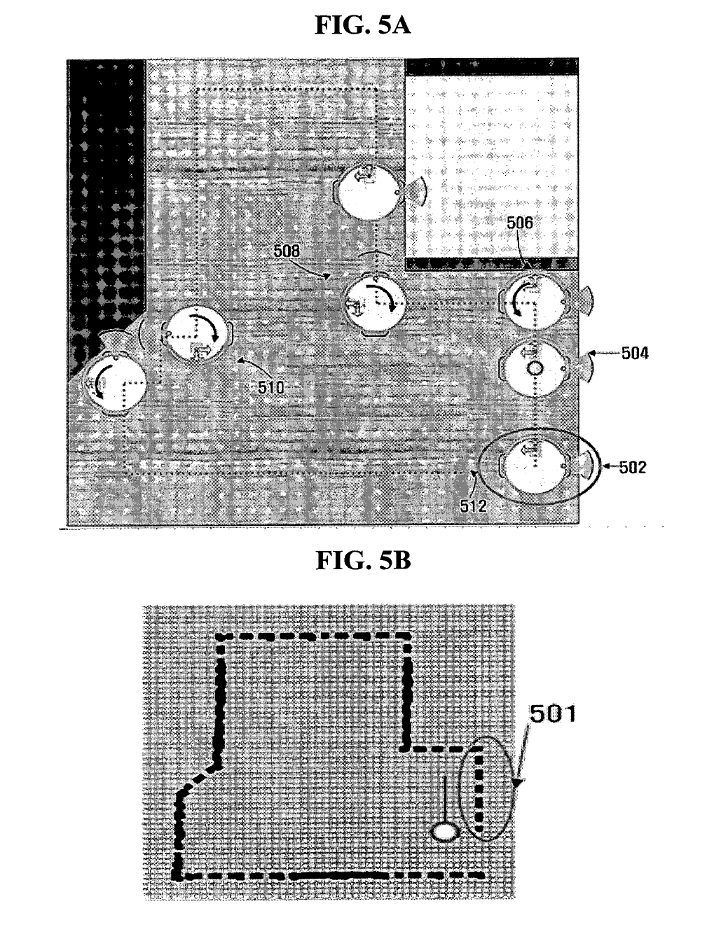

In operation S256, when the body 105 moves forward, the control unit 150 turns the body 105 toward a specified direction at a right angle on the basis of the center azimuth, when the distance between the body 105 and the obstacle positioned on the side of the body 105 is longer than a first critical value. For example, when the body 105 moves, while the wall is positioned on the right side of the body 105, the distance between the body 105 and the wall positioned on the right of the body 105 may be longer than the first critical value. In this instance, the control unit 150 turns the body 105 toward a right direction at a right angle on the basis of the center azimuth. The above description on the vertical relation of the wall will be referred to the description on a model structure of the house interior shown in FIGS. 5A and 5B.

After that, it is determined whether the traveling path of the body 105 forms a closed loop in operation S261 described in FIG. 2, the drawing unit 160 again produces the geometric map in which the produced map has been subjected to the smoothing process through a desired method. At that time, the drawing unit 160 may update the grid map and process the smoothing in rear time to produce the geometric map.

FIGS. 4A and 4B are views explaining the process of measuring the absolute azimuth of the obstacle initially positioned on the side of the body according to an embodiment of the present invention.

Referring to FIGS. 1A, 1B, 4A, and 4B, the control unit 150 turns the body 105 in accordance with the absolute azimuth of the obstacle positioned on the side of the body 105 by use of information provided from at least one of the compass unit 120, the encoder unit 130, and the sensor unit 140, so that the body 105 is positioned in parallel with the absolute azimuth of the obstacle positioned on the side of the body 105. The absolute azimuth of the obstacle positioned on the side of the body 105 is measured when the center azimuth of the interior of the specified area is initially set. In the subsequent control, it may be not be advantageous to measure the absolute azimuth of the obstacle positioned on the side of the robot. If the center azimuth of the interior of the specified area which is a reference line is initially set, the center azimuth of the interior of the specified area initially set is used as the reference value to be used in the subsequent control.

The absolute azimuth of the obstacle positioned on the side of the body 105 is measured by subtracting an angle formed by the body 105 and the obstacle positioned on the side of the body 105 from the average value of the absolute azimuth indicating the orientation of the body 105 measured during a specified time, which will be described in detail hereinafter with reference to FIGS. 4A and 4B.

For example, in order to measure the direction of the wall (i.e., the obstacle) in which the body 105 is initially positioned, it may be advantageous to position the body 105 of the robot 100 on the long wall (e.g., a right wall) and then move the body 105 forward.

As shown in FIG. 4A, letting the position on which the body 105 is firstly positioned, be an initial position, and the position on which the body 105 is currently positioned after it moved forward along a desired distance, be a current position, a heading angle of the body 105, i.e., an angle 402 formed by the body 105 and the wall, is measured.

As shown in FIG. 4B, the angle formed by the body 105 and the wall may be defined by Equation 1.

$${sin}^{- 1} \frac{{d}_{1} - {d}_{0}}{D} \qquad [ Equation 1 ]$$

Here, d₁-d₀ is a value resulted by subtracting a distance (d₀) between the body of the initial position, on which the robot 100 is firstly positioned, and the wall from a distance (d₁) between the body 105 of the current position, on which the robot 100 is currently positioned after it moved forward along a desired distance, and the wall, and D means a traveling distance of the body 105.

The absolute azimuth of the wall positioned on the side of the body 105 is measured by subtracting the angle 402 formed by the body 105 and the wall from the average value of the absolute azimuth indicating the orientation of the body 105 measured during a desired time. The control unit 150 turns the body 105 in accordance with the measured absolute azimuth of the wall, so that the body 105 is positioned in parallel with the absolute azimuth of the wall positioned on the side of the body 105. The absolute azimuth of the wall initially positioned on the side of the body 105, that is, the center azimuth of the interior of the house, may be defined by Equation 2.

$${\tilde{θ}}_{0} - {sin}^{- 1} \frac{{d}_{1} - {d}_{0}}{D} \qquad [ Equation 2 ]$$

Here,

$${sin}^{- 1} \frac{{d}_{1} - {d}_{0}}{D}$$

is the angle 402 formed by the body 105 and the wall, and \tilde{θ}₀ is the average value of the absolute azimuth indicating the orientation of the body 105 measured during the desired time.

In this instance, the average value (\tilde{θ}₀) of the absolute azimuth indicating the orientation of the body 105 measured during the desired time may be defined by Equation 3.

$${\tilde{θ}}_{0} = \frac{{\sum }_{k = 1}^{N} {θ}_{k}}{N} \qquad [ Equation 3 ]$$

Here, N is a measuring frequency of the compass (sensor) while the robot 100 moves forward. Supposing that a sampling time of the compass is ts (msec), and the time required for the forward movement of the body 105 to calculate the direction of the wall (obstacle), on which the body 105 is firstly positioned, is T, it may be defined by N=T/ts. Also, in Equation 3, θₖ indicates the absolute azimuth of the k-th sampling time.

The control unit 150 performs the operation by moving the body 105 forward and turning the body 105 toward a specified direction at a right angle so as to maintain the distance between the body 105 and the obstacle positioned on the side or front of the body 105 at a specified range. Therefore, the robot can perform the mapping for the traveling path of the body 105 promptly.

FIGS. 5A and 5B are views illustrating a traveling route of the robot using the absolute azimuth and an example of performing the mapping of the robot based on the traveling route, according to an embodiment of the present invention. In FIG. 5A, several locations are identified by reference numerals, as explained below.

The traveling route of the robot 100 of FIGS. 1A and 1B using the absolute azimuth according to the flowcharts shown in FIGS. 2 and 3 and the process of performing the mapping based on the traveling route will now be described with reference to an internal model structure of the house.

As shown in FIG. 5A, after the body 105 of the robot 100 is positioned on the long wall (e.g., the right wall) which is a main structure in the house, the body moves forward (502). At that time, the control unit 150 measures the absolute azimuth of the right wall through the method shown in FIG. 4, and turns the body 105 according to the center azimuth, so as to position the body 105 in parallel with the right wall. When the conventional robot performs the mapping for the specified area, the robot is continuously controlled by use of the algorithm so that the robot travels in parallel with the obstacle positioned on the side of the robot according to the wall-following method. However, the control unit 150 performs the operation by moving the body 105 forward and turning the body 105 toward a specified direction at a right angle so as to maintain the distance between the body 105 and the obstacle positioned on the side or front of the body 105 at a specified range. The drawing unit 160 performs the mapping using information from the control unit 150, which may include information from the first side sensor 143, based on the traveling path of the body 105. The map may be a grid type map, as shown in FIG. 5B.

In this instance, an ultrasonic sensor may be mounted on the side or front of the body 105 to output the distance information between the body 105 and the wall positioned on the side or front of the body 105 (504). The sensor unit 140 can measure the distance between the body 105 and the obstacle by emitting the supersonic waves toward the obstacle and receiving the reflected waves. As such, the map is updated and produced. Also, a contact detecting sensor (e.g., the bumper 149) may be mounted on the front of the body 105 to detect whether the body 105 contacts the obstacle.

While the body 105 moves forward, the control unit 150 turns the body 105 toward the left direction at a right angle, and again moves the device forward, when the body 105 comes in contact with the obstacle positioned on the front of the body 105 (506).

When the body 105 moves forward, the control unit 150 turns the body 105 toward the right direction at a right angle, and again moves the body 105 forward, when the distance between the body 105 and the wall positioned on the right of the body 105 is longer than the first critical value, due to the vertical relation of the interior of the house (508).

Also, when the body 105 moves along an inclined wall, the control unit 150 controls the body 105 in accordance with the distance between the body 105 and the wall positioned on the side of the body 105, and the distance between the body 105 and the wall positioned on the front of the body 105. The control unit 150 turns the body 105 toward the right direction at a right angle, and again moves the body 105 forward, when the distance between the body 105 and the wall positioned on the right of the body 105 is longer than the first critical value. Also, the control unit 150 turns the body 105 toward the left direction at a right angle, and again moves the body 105 forward, when the body collides against the obstacle positioned on the front of the body 105 (510).

As such, the control unit 150 performs the control operation by turning the body 105 toward the left/right direction at a right angle according to the distance between the body 105 and the wall, so as to maintain the distance between the body 105 and the wall at a specified range. Therefore, the robot can perform the mapping for the traveling path of the body 105 promptly. In this instance, a gyro sensor and a compass sensor may be mounted on the body 105, so that the body is simply controlled by the perpendicular direction (i.e., right-angle turning).

If the body 105 of the robot 100 is again positioned on the initial position to form a closed loop while it circulates in the area of the house (512), the produced map is subjected to the smoothing process, thereby processing the map more smoothly.

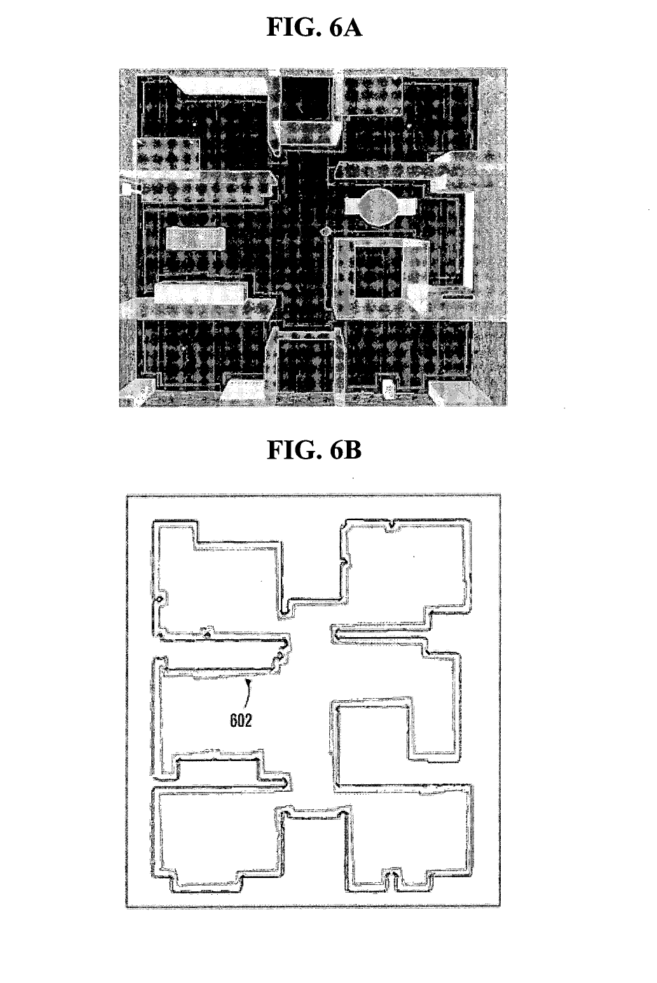

FIGS. 6A and 6B are views displaying the results of a simulation on the traveling path of the robot 100 using the absolute azimuth according to an embodiment of the present invention.

FIG. 6A shows the simulation on the traveling path of the body 105 according to the internal structure of a building, and FIG. 6B is a view displaying the results of the simulation in FIG. 6A. The grid map produced by the body 105 which starts at the initial position and again positions on the initial position to form the closed loop is shown as an example. Reference numeral 602 indicates an actual traveling path 602 of the body 105. The robot draws out the map of the wall by use of the position of the robot and the distance between the robot and the wall which is measured by the lateral detecting sensor. The grid map may be again produced as the geometry map through the method yielding the results shown in FIGS. 7A and 7B.

FIGS. 7A and 7B are views illustrating examples of a map smoothing technique.

FIG. 7A is an occupancy grid map and FIG. 7B is a polygonal map for representing the map.

As shown in FIG. 7A, the occupancy grid map is produced through the map updating. Each of the grids is represented by the probability of the presence of obstacles in a range of values from 0 to 15. As the value is increased, the probability of the presence of an obstacle. Conversely, as the value is decreased, the probability of the presence of an obstacle decreases. And, when the value is zero, there is no obstacle in the corresponding grid.

As shown in FIG. 7B, the polygonal map represents the boundary of the obstacle (e.g., the wall) as a geometry model (e.g., lines, polygons, circles, and the others). That is, after the occupancy grid is stored as an image, each grid is represented by a line or curve (i.e., the map smoothing) through a “split and merge” image segmentation algorism used in an image processing, and the map may be easily represented by the line or curve. For example, the polygonal map may be produced in rear time by updating the occupancy grid through a CGOB (certainty grid to object boundary) method. This method is discussed in an article by John Albert Horst and Tsung-Ming Tsai, entitled “Building and maintaining computer representations of two-dimensional mine maps”.

According to the above-described embodiments of the present invention, the robot using the absolute azimuth and the mapping method thereof have the following advantages.

The robot can perform the mapping of a specified area promptly through the control operation, without accumulating azimuth errors.

Because of the simplified construction of the robot, the manufacture of the robot is convenient and less expensive and its efficiency is increased.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A robot using an absolute azimuth to navigate, comprising:
a control unit controlling a traveling direction of a body of the robot using the absolute azimuth, which indicates an orientation of the body with respect to a specified reference axis; and
a drive unit moving the body under the control of the control unit.

2. The robot of claim 1, further comprising a drawing unit mapping an area in which the robot resides based on a traveling path of the body.

3. The robot of claim 2, wherein, before the drawing unit performs the mapping, the control unit turns the body in accordance with the absolute azimuth of an obstacle positioned on a side of the body, so that the body is parallel with the obstacle, and the absolute azimuth of the obstacle indicates the orientation of the body with respect to the reference axis.

4. The robot of claim 3, wherein the absolute azimuth of the obstacle is determined by subtracting an angle formed by the body and the obstacle positioned on the side of the body from an average value of the absolute azimuth measured during a specific time.

5. The robot of claim 2, wherein the map is a grid map, or a geometric map in which the grid map is subjected to a smoothing process by the drawing unit.

6. The robot of claim 1, wherein the control unit turns the body in a specified direction at a right angle to maintain a distance between the body and an obstacle positioned in front of or at a side of the body, at a desired range.

7. The robot of claim 6, wherein the control unit turns the body at a right angle, when the distance between the body and the obstacle is longer than a first critical value and the obstacle is on the side of the body or when the distance between the body and the obstacle is shorter than a second critical value and the obstacle is in front of the body.

8. The robot of claim 6, further comprising:
a first sensor outputting information on the distance between the body and the obstacle, when the obstacle is on the side of the body; and
a second sensor outputting information on the distance between the body and the obstacle, when the obstacle is in front of the body.

9. The robot of claim 8, wherein the first sensor or the second sensor includes at least one of an ultrasonic sensor, an infrared sensor, and a laser sensor.

10. The robot of claim 6, wherein the control unit turns the body at a right angle, when the body contacts the obstacle and the obstacle is in front of the body.

11. The robot of claim 10, further comprising a contact detecting sensor detecting contact between the body and the obstacle when the obstacle is in front of the body.

12. The robot of claim 1, further comprising:
a compass unit outputting information on the absolute azimuth indicating an orientation of the body; and
an encoder unit detecting operation of the drive unit to output information on at least one of a traveling distance, a traveling speed, and a turning angle of the body.

13. A mapping method of a robot using an absolute azimuth for navigation, comprising:
controlling a traveling direction of a body of the robot using the absolute azimuth, which indicates an orientation of the body with respect to a specified reference axis; and
moving the body under control of a control unit.

14. The method of claim 13, further comprising mapping based on a traveling path of the body.

15. The method of claim 14, further comprising turning the body in accordance with the absolute azimuth of an obstacle positioned on a side of the body before the mapping, so that the body is parallel with the obstacle, the absolute azimuth of the obstacle indicating the orientation of the body with respect to the reference axis.

16. The method of claim 15, wherein the absolute azimuth of the obstacle is determined by subtracting an angle formed by the body and the obstacle positioned on the side of the body from an average value of the absolute azimuth measured during a specified time period.

17. The method of claim 14, wherein the map is a grid map, or a geometric map in which the grid map is subjected to a smoothing process.

18. The method of claim 13, wherein the body is turned in a specified direction at a right angle to maintain a distance between the body and the obstacle positioned in front of or on a side of the body, at a desired range.

19. The method of claim 18, wherein the body is turned at a right angle, when the distance between the body and the obstacle is longer than a first critical value and the obstacle is on the side of the body or when the distance between the body and the obstacle is shorter than a second critical value and the obstacle is in front of the body.

20. The method of claim 18, further comprising:
outputting information on the distance between the body and the obstacle, when the obstacle is on the side of the body; and
outputting information on the distance between the body and the obstacle, when the obstacle is in front of the body.

21. The method of claim 20, wherein the distance is determined using at least one of an ultrasonic sensor, an infrared sensor, and a laser sensor.

22. The method of claim 18, wherein the body is turned at a right angle, when the body contacts the obstacle and the obstacle is in front of the body.

23. The method of claim 22, further comprising detecting whether the body contacts the obstacle and the obstacle is in front of the body.

24. The method of claim 13, further comprising:
outputting information on the absolute azimuth, which indicates the orientation of the body; and
outputting information on at least one of a traveling distance, a traveling speed, and a turning angle of the body.

25. A robot, comprising:
a drive unit advancing the robot along a traveling path in a specified area;
a compass unit outputting information about an absolute azimuth indicating an orientation of the robot;
a sensor unit sensing a distance between the robot and an obstacle;
a control unit determining, using the sensed distance, an absolute azimuth of the obstacle based on the measured distance, when the obstacle is on the side of the robot, based on an average value of the absolute azimuth measured for a specified time, turning the robot in accordance with the measured absolute azimuth of the obstacle so that the absolute azimuth of the robot is parallel to the absolute azimuth of the obstacle, then moving the robot forward by turning the robot according to the measured absolute azimuth of the obstacle so that the absolute azimuth of the robot is parallel to the absolute azimuth of the obstacle; and
a drawing unit mapping the specified area based on the traveling path of the robot and, when the traveling path is a closed loop, smoothing a generated map.

26. A method of improving an accuracy of mapping of a specified area, comprising:
advancing a robot along traveling path;
outputting information indicating an orientation of the robot;
sensing a distance between the robot and an obstacle;
determining, using the sensed distance, an absolute azimuth of the obstacle based on an average value of the absolute azimuth indicating an orientation of the body measured for a specified time;
mapping the specified area based on the traveling path; and
determining whether the traveling path of the body forms a closed loop and smoothing the map when the traveling path of the body forms a closed loop.

27. A robot, comprising:
a control unit controlling movement of the robot in a specified area using an absolute azimuth of the robot so that the robot maintains a predetermined distance range from an obstacle positioned on a side of the robot, by moving the robot forward and/or toward in a specified direction at a right angle, on the basis of a center azimuth of an interior of the specified area; and
a drawing unit mapping the specified area using information from the control unit based on a traveling path of the robot,
wherein the absolute azimuth is an angle inclined with respect to a reference axis and indicating an orientation of the robot with respect to the reference axis, and
wherein the reference axis is a center azimuth of an interior of the specified area.
